(19) United States
(12) Patent Application Publication
(10) Pub. No.: US 2021/0040281 A1
(43) Pub. Date: Feb. 11, 2021

(54) FREE STANDING PLEATABLE BLOCK COPOLYMER MATERIALS AND METHOD OF MAKING THE SAME

(71) Applicant: TeraPore Technologies, Inc., South San Francisco, CA (US)

(72) Inventors: Rachel M. Dorin, San Carlos, CA (US); Spencer Robbins, San Carlos, CA (US); Jayraj K. Shethji, San Francisco, CA (US)

(21) Appl. No.: 16/979,611

(22) PCT Filed: Mar. 12, 2019
(86) PCT No.: PCT/US2019/021820

§ 371 Date: Sep. 10, 2020

Related U.S. Application Data
(60) Provisional application No. 62/641,660, filed on Mar. 12, 2018.

(51) Int. Cl. C08J 5/18; C08J 9/36; B01D 71/26; B01D 71/28; B01D 71/80; B01D 69/02; B01D 67/00

(52) U.S. Cl. CPC C08J 5/18; C08J 9/36; B01D 71/26; B01D 71/28; B01D 71/80; B01D 63/14; B01D 67/0016; C08J 2201/03; C08J 2353/00; B01D 2325/022; B01D 69/02

(57) ABSTRACT

Embodiments disclosed herein provide a pleatable freestanding isoporous block-copolymer (“BCP”) thin films fabricated sans substrate at a size suitable for fabricating pleated cartridges. The thin films have narrow pore size distribution, are mechanically robust, and have exceptional separation performance. These porous BCP thin films are useful as filtration media and separation membranes and are amenable to standard manufacturing practices.

### CROSS-REFERENCE TO RELATED APPLICATION

This application claims the benefit of U.S. Provisional Application No. 62/641,660 filed Mar. 12, 2018, the entire contents of which are incorporated by reference herein.

### FIELD OF THE DISCLOSURE

The disclosure relates generally to large area, pleatable, freestanding isoporous asymmetric block copolymer (“BCP”) thin film membranes (films) and uses of such films in separation and purification applications.

### BACKGROUND OF THE DISCLOSURE

A membrane is a porous semi-permeable filtration media that separates solutes based on their size. Traditionally, membranes are fabricated from conventional polymers such as polysulfone, polyether sulfone, polyacrylonitrile, cellulose based polymers, polytetrafluoroethylene, polyvinylidene fluoride, polyvinylchloride, etc. The membranes fabricated using these polymers are synthesized by well-known immersion precipitation processes. For example, the dope solution may be extruded on a highly open macroporous support, and then quickly immersed into a non-solvent bath (water) to form a film on the support that acts as a membrane. This process is typical for dense membranes and membranes with pore sizes in the range of a few nanometers to 70 nanometers. It is also common for larger pore sizes. An alternate process is to extrude the dope on an impermeable support and then separate the membrane from that support after a period of evaporation, before or after immersion in the non-solvent bath. In order to have sufficient strength, membranes formed without an integral support are quite thick, on the order of 100 to 250 microns in thickness, and usually have large pores sizes, on the order of a micron, or have a large pore size gradient with smaller pores on one or both surfaces and much larger pores through a large portion of the thickness of the membrane.

Typically, a commercial membrane fabrication process is conducted on a continuous roll-to-roll processing platform. During the membrane fabrication process, the membrane is subjected to variable tension, and the macroporous open support, or the large thickness of the membrane, aids in preventing damage that excessive tension would otherwise cause due to excessive stress or excessive strain. This additional support provides additional strength during the fabrication process and makes it feasible to make a high volume of material in roll-to-roll format on a larger scale. The strength provided by the support or large membrane thickness also makes handling of the membrane in the fabrication of filter cartridges and cassettes economically possible, thus making production of commercial filtration systems feasible. While the support provides additional mechanical strength, it increases the total thickness of the membrane thereby increasing the mass transfer resistance and decreasing the permeability of the membrane. A thick membrane also has a necessarily smaller packing density (surface area per unit volume) in a completed cartridge or cassette than a thinner membrane. Thus the additional strength is achieved at the loss of packing density, which is a critical parameter of filter performance. Another drawback of using a porous support is that any foreign particles or dust on the support, or surface roughness, deformation, or other material defects, might introduce defects, such as micron-size pinholes, into the final membrane which diminish its performance. Defect reduction in separation media is of paramount importance as any small defect that is larger than the average pore diameter will let through solutes that contaminate the permeate. The density of defects is exacerbated as the media fabrication is scaled from laboratory scale to pilot scale. These defects often arise from the support on which the film is cast.

Membrane curling or tubing upon drying is an undesirable property. The curling or tubing leads to change in membrane structural, transport and rejection characteristics. Supported BCP membranes can curl after drying. This might be due to a propensity of the support material to curl after drying or to unequal deformation of the membrane and the support during drying. In addition, uncurling the membrane, to make it useful in a filtration device, tends to cause cracks and other deformations deleterious to function.

Finished membranes are generally packaged into several different types of commercial module configurations including cassettes, cartridges, and other devices. The membranes are sealed into these devices by different sealing mechanisms such as ultrasonic welding, heated dies, gluing and radio frequency welding. Thermal and mechanical compatibility between the membrane and housing are important factors in achieving a hermetic seal between the membrane and housing. An additional layer of macroporous support with different properties compared to freestanding film can add to the complexity in making the modules. Due to all the aforementioned reasons, it is preferable to avoid using the support, or gaining strength by increasing membrane thickness, if possible.

Pleated membrane filters from commercial polymers are widely used in many separation applications. Pleated membrane formats offer significantly higher surface area to volume ratios of filter media packed into modules, compared to flat sheet cassettes, and reduced flow path lengths, which reduces pressure drop, compared to spiral wound cartridges. Pleating minimizes the membrane footprint and improves filtration process economics. Typically, pleated membrane cartridges are made by folding a continuous flat sheet of membrane in an accordion-fashion. Traditional phase inverted membranes are also typically heated during pleating, in order to avoid cracking when pleated at a small radius, or to further prevent “springback” upon pleating at a large radius. The pleated sheet is inserted into a housing and the edges are sealed by heat sealing or potting methods.

Depending on the thickness, types of solvents used to make the dope solution, and the type of open porous support, supported BCP membranes are also susceptible to cracking when pleated in wet and dry state. These membranes need to be kept wet or heated into plastic deformation, otherwise there is a possibility of introducing cracking or other types of defects such as pin holes during pleating. For both simplicity in processing and to eliminate any potential oxidation/degradation of some block chemistries, it can be beneficial to avoid unnecessary heating of BCP-based membranes.

One of the unique advantages of BCP systems is their ability to self-assemble into nanoscale structures and form uniformly sized micelles in the casting solution, which in turn, provides a highly ordered isoporous structure on the membrane's surface. The highly ordered uniformly sized pores give a very sharp molecular weight cut-off and provide excellent selectivity for separating molecules of differing size. Such a BCP film is disclosed in US 2014/0217012 A1, which describes the fabrication of such membranes through a combination of controlled solvent evaporation and well-established immersion precipitation processes, known as self-assembly and non-solvent induced phase separation (SNIPS). However, as stated in the disclosure of US 2014/0217012 A1, the maximum membrane area that was demonstrated was 300 cm². While a membrane of less than 300 cm² of BCP thin film can be made by traditional doctor blade methods, fabricating a large freestanding BCP thin film suitable for commercial use is challenging. One particular challenge is the adhesion of the BCP film with the nonporous substrate used for casting; it can easily delaminate from the substrate during fabrication and break apart before phase inversion yields a continuous film.

### BRIEF DESCRIPTION OF THE DRAWINGS

FIG. 1 is a scanning electron microscope (SEM) image of the selective layer of a pleatable freestanding asymmetric isoporous BCP film.

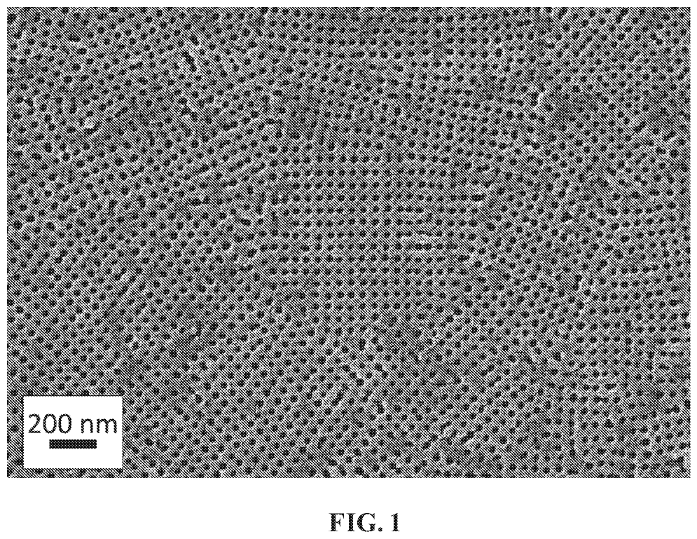

FIGS. 2A-C are photographs of stages of testing the pleatability of a disc of a poly(isoprene-b-styrene-b-4-vinypyridine) (ISV) BCP film cut from a larger section. FIG. 2A shows a disc of ISV BCP film. FIG. 2B shows a disc of ISV BCP film folded on itself. FIG. 2C shows a disc of ISV BCP film tested in a polypropylene holder after folding and unfolding multiple times. The crease at the center of the disc is caused by pleating; the film was challenged with 20 nm gold nanoparticles solution, and the rejection of gold nanoparticles was >99.9%. The discoloration on the surface of the film is due to adsorbed gold nanoparticles.

FIG. 3 is a plot of hydraulic permeability of a substrate supported BCP film (228 μm) compared with a freestanding BCP film (64 μm).

### DETAILED DESCRIPTION OF THE INVENTION

The following description of the embodiments is merely exemplary in nature and is in no way intended to limit the subject matter of the present disclosure, their application, or uses.

As used throughout, ranges are used as shorthand for describing each and every value that is within the range. Any value within the range can be selected as the terminus of the range.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, and alternatively ±1 percent of the given numeric value provided such a deviation does not after the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The disclosure herein is particularly directed to large area pleatable isoporous asymmetric block copolymer (“BCP”) films (sometimes referred to herein as “membranes”) that are freestanding, mechanically robust, and capable of separating solutes of interest at much higher permeabilities than by the use of porous membranes known to the prior art. A large area film is defined as one of sufficient area to fabricate a commercial filter cartridge. For example, areas in the range of 300 square centimeters to 1.0 square meters are sufficient to fabricate a commercial filter cartridge.

The disclosure is additionally directed towards methods of manufacturing such membranes at commercial scale. Example embodiments disclosed herein relate to fabrication of pleatable isoporous freestanding films from block copolymers on a traditional roll-to-roll platform. These embodiments are not intended to restrict the method of fabrication of the inventive membranes in any way.

Thin films prepared by the SNIPS method, described above, are composed of two distinct layers made from the same precursor BCP material. The first layer is a thin, mesoporous semipermeable skin layer, and the second layer beneath it is a relatively open, macrovoid-containing, support layer. Even though the films disclosed herein lack an additional porous support, the less dense support layer of the films surprisingly provides sufficient structural support to prevent rupture or cracking under operating conditions, even though it is substantially thinner than what has been found to be necessary for traditional membranes, as discussed previously. While not wishing to be bound by theory, one potential reason for the robustness of the thin films is related to their self-assembled structure. A great benefit of the exceptionally thin films disclosed herein is that the membrane may be folded around a much smaller radius than would be possible for traditional thicker membranes without the heating or wetting required to prevent defects that would otherwise be produced in pleating of traditional membranes. This allows a substantial improvement in packing density and manufacturability of pleated cartridges made from these thin film membranes. Another significant benefit of these thin films is the low hydraulic resistance to the transport of the fluids which substantially increases the permeability of the membrane compared to thicker alternatives.

In accordance with various aspects of the present disclosure, a method for forming a asymmetric freestanding isoporous BCP film includes the steps of: (a) formulating a polymer solution by mixing at least one block copolymer, wherein at least one BCP is combined with at least one solvent; (b) extruding the polymer solution into a film on a nonporous substrate; (c) evaporating at least a portion of at least one chemical of the polymer solution; and (d) immersing the film into a coagulation bath.

In accordance with various aspects of the present disclosure, another method for forming an asymmetric freestanding isoporous BCP film includes the steps of: (a) formulating a polymer solution by mixing at least one block copolymer, wherein at least one BCP is combined with at least one solvent; (b) extruding the polymer solution into a film on a nonporous substrate; (c) evaporating at least portion of at least one chemical of the polymer solution; (d) immersing the film into a coagulation bath; and (e) rinsing the BCP film.

While not wishing to be bound by any theory, one or a combination of the effects of movement of the web (film with substrate), solvent system, the rate of evaporation of solvent under controlled process conditions, the properties of the BCP film or the properties of the non-porous release film might lead to drying of the ˜5 mm outer edges of the thin film. The dry edges form a seal and are fixed to the non-porous substrate. This effect prevents delamination of the film during the continuous casting process. The film stays adhered to the non-porous substrate during the entire casting process. Surprisingly, the edges adhere strongly enough to adhere during the entire casting process yet can release from the non-porous substrate using a small amount of force, without damaging the material.

One consideration for making large continuous areas of pleatable film is that the film ideally should be easily released from the non-porous substrate after the casting process without damage. While not bound by any theory, the above process may create a gradient in adhesive strength between the BCP and the non-porous release film; the edges form a seal between the non-porous substrate and BCP film, and the interior portions of the BCP film do not tightly adhere to the non-porous support, allowing easy delamination after casting.

It should be noted that the edge adhering mechanism described above is simply one example of adhering the edges to the substrate, and there are several other ways to keep the film adhered to the substrate during the casting process. One way is to use a process similar to tentering whereby many closely spaced clips at the edge of the film and substrate keep the film and substrate together. Another way is to use an air knife or blower or vacuum box to secure the film onto the substrate. In addition to the above, multiple other methods for keeping the film and substrate in close proximity can be used.

In at least one embodiment, the non-porous substrate can be polyester, polyethylene, polyvinylidene fluoride, polytetrafluoroethylene, polymethyl methacrylate or stainless steel.

In at least one embodiment, the polymer solution comprises at least one of the following: Acetic acid, Acetone, Acetonitrile, Benzene, Chloroform, Cyclohexane, Dichloromethane, Dimethoxyethane, Dimethyl sulfoxide, Dimethylacetamide, Dimethylformamide, 1,4-Dioxane, Ethanol, Ethyl acetate, Formic acid Hexane, Methanol, N-Methyl-2-pyrrolidone, Propanol, Pyridine, Sulfolane, Tetrahydrofuran, or Toluene.

In at least one embodiment, the coagulation bath comprises water. In at least one embodiment, the coagulation bath comprises water and isopropyl alcohol.

In at least one embodiment, the concentration of the BCP in the casting solution is in the range of about 1% to about 30% by weight. In other embodiments, the concentration of the BCP in the casting solution is in the range of about 5% to about 20% by weight. In other embodiments, the concentration of the BCP in the casting solution is in the range of about 7% to about 25% by weight.

In at least one embodiment, the film can be defined as a large area pleatable isoporous asymmetric freestanding (without an additional porous support) film made from a precursor BCP material.

In at least one embodiment, pleatability or being “pleatable” refers to the ability of a film to be folded and unfolded and still retain the ability to reject solutes of size greater than average pore diameter of the selective layer. A test to determine pleatability of a film according to the present disclosure involves the following steps: (1) Optionally, drying the film at ambient conditions for at least 24 hours; (2) cutting a testable film sample with an area of at least 78 mm² from a larger film sheet; (3) optionally, if not dried at step 1, allowing the film sample to dry at ambient conditions for at least 24 hours; (4) folding the film sample first towards the selective side; (5) putting a weight of at least 150 g on the film sample folded in half such that both the halves are in close contact with each other for at least 24 hours; (6) unfolding the film sample and again putting at least 150 g of weight on the non-selective side for at least 24 hours; (7) putting the unfolded film sample into a test cell; (8) challenging the film sample with a solute (such as nanoparticles, nanospheres, bacteria, viruses, proteins, etc.) of known diameter that has at least two dimensions greater than the average pore diameter of the skin of the film sample; and (9) performing mass balance on feed and permeate samples to determine the rejection of the solute.

Embodiments of the films disclosed herein show >99.9% rejection of solutes having at least two perpendicular dimensions greater than the average pore diameter of the film. Embodiments of the films disclosed herein do not crack or disintegrate when pleated, or even when crumpled in the wet or dry state. The robustness of the films in dry state allows heat-free pleating, avoiding possible defects that may derive from heat pleating. Being able to pleat a film is desirable to increase the area of membrane that can fit in a packaged module's given volume. Furthermore, being able to pleat without heating minimizes the complexity and cost of manufacturing the film and final separation device.

Embodiments of the films disclosed herein have an asymmetric (anisotropic) structure. Asymmetric membranes are not homogeneous through their depth and may have a gradient of average pore size from one depth portion to another. One layer of an asymmetric membrane according to present disclosure is thin and can be referred to as a “skin” layer, which is the actual selective barrier of the asymmetric structure and responsible for the membrane selectivity. Underneath the skin layer is a substrate layer. In accordance with various aspects of the present disclosure, the substrate layer can either be open with macrovoids or have a sponge-like structure. The substrate layer provides additional support to the skin layer during separation processes. In some instances, in asymmetric membranes, the pore size changes from small pores in the skin layer to larger pores in the substrate layer.

In at least one embodiment, porous pleatable freestanding block copolymer films are provided. A portion of the pores are “isoporous”: having a substantially narrow pore diameter distribution. A portion of the pores of the thin films disclosed herein are “mesoporous”: with pore diameters between 1 nm and 200 nm. In some embodiments, the average pore diameter of a thin film's skin according to the present disclosure ranges from about 1 nm to about 5 nm. In some embodiments, the average pore diameter ranges from about 4 nm to about 15 nm. In some embodiments, the average pore diameter ranges from about 10 nm to about 25 nm. In some embodiments, the average pore diameter ranges from about 20 nm to about 50 nm. In some embodiments, the average pore diameter ranges from about 5 nm to about 50 nm. In some embodiments, the average pore diameter ranges from about 6 nm to about 100 nm. In some embodiments, the average pore diameter ranges from about 6 nm to about 200 nm. In some embodiments, the average pore diameter ranges from about 10 nm to about 100 nm. In some embodiments, the average pore diameter ranges from about 14 nm to about 50 nm. In some embodiments, the average pore diameter ranges from about 50 nm to about 100 nm. In some embodiments, the average pore diameter ranges from about 100 nm to about 200 nm.

In at least one embodiment, at least a portion of the mesopores are isoporous and comprise the “skin” of the film. In instances where at least a portion of the mesopores are isoporous and comprise the “skin” of the film, such film can have a thickness of about 5 μm to about 75 μm. In some embodiments, the thickness of the film can range from about 10 μm to about 75 μm. In some embodiments, the thickness of the film can range from about 15 μm to about 75 μm. In some embodiments, the thickness of the film can range from about 20 μm to about 75 μm. In some embodiments, the thickness of the film can range from about 25 μm to about 45 μm. In some embodiments, the thickness of the film can range from about 45 μm to about 75 μm.

The radius of curvature of the thin films disclosed herein is defined as the radius of the largest cylinder on which a strip of a thin film fractures when wrapped 180 degrees around the cylinder. In at least one embodiment, a pleatable film in accordance with the present disclosure has a radius of curvature of at most about 0.1 mm. In at least one embodiment, a pleatable film in accordance with the present disclosure has a radius of curvature of at most about 0.2 mm. In at least one embodiment, a pleatable film in accordance with the present disclosure has a radius of curvature of at most about 0.3 mm. In at least one embodiment, a pleatable film in accordance with the present disclosure has a radius of curvature of at most about 0.4 mm. In at least one embodiment, a pleatable film in accordance with the present disclosure has a radius of curvature of at most about 0.5 mm. In at least one embodiment, a pleatable film in accordance with the present disclosure has a radius of curvature of at most about 0.6 mm. In at least one embodiment, a pleatable film in accordance with the present disclosure has a radius of curvature of at most about 0.7 mm. In at least one embodiment, a pleatable film in accordance with the present disclosure has a radius of curvature of at most about 0.8 mm. In at least one embodiment, a pleatable film in accordance with the present disclosure has a radius of curvature of at most about 0.9 mm. In at least one embodiment, a pleatable film in accordance with the present disclosure has a radius of curvature of at most about 1.0 mm.

The typical usage of the term “block copolymers” refers to the simplest block copolymers which comprise two or more linear segments or “blocks” wherein adjacent segments include different constituent units, with only one constituent unit in each block. However, this simple architecture is not the only architecture that can result in self-assembly on the nano- and meso-scales. Such architectures, which will be referred to as complex block or copolymer architectures, can include, for example, intermediate non-repeating units between blocks (junction blocks) and varying end groups at the termini of chains. Even more complex block architectures and block copolymer architectures exist, wherein at least a portion of one block or at least a portion of one junction block or one or more end groups comprise a structure or composition more complex than a linear single constituent unit chain. Such complex architectures include but are not limited to: periodic or random mixtures of different constituent units in one or more blocks, graft copolymer blocks, ring blocks or block copolymers, gradient blocks, or crosslinked blocks. Any block copolymer architecture/topology that allows incompatible segments of the block copolymer to phase separate (self-assemble) into distinct domains and be processed using the methods disclosed to generate porous block copolymer materials is suitable.

Some examples of suitable block chemistries include, but are not limited to: Poly(isobutylene), Poly(isoprene), Poly(butadiene), Poly(propylene glycol), Poly(ethylene oxide), Poly(dimethylsiloxane), Poly(ethersulfone), Poly(sulfone), Poly(hydroxystyrene), Poly(methylstyrene), Poly(ethylene glycol), Poly(2-hydroxyethyl methacrylate), Poly(acrylamide), Poly(N,N-dimethylacrylamide), Poly(propylene oxide), Poly(styrene sulfonate), Poly(styrene), Poly(ethylene), Poly(vinyl chloride), Poly(2-(perfluorohexyl)ethyl methacrylate), Poly(tetrafluoroethylene), Poly(vinylidene fluoride), Poly(pentafluorostyrene), Poly(acrylic acid), Poly(2-vinylpyridine), Poly(4-vinylpyridine), Poly(3-vinylpyridine), Poly(N-isopropylacrylamide), Poly(dimethylaminoethyl methacrylate), Poly(glycidyl methacrylate), Poly(ethyleneimine), Poly(lactic acid), Poly(acrylonitrile), Poly(methyl acrylate), Poly(butyl methacrylate), Poly(methyl methacrylate), Poly(n-butyl acrylate), Poly(amic acid), Poly(isocyanate), Poly(ethyl cyanoacrylate), Poly(allylamine hydrochloride), or a substituted equivalent of any of the above.

Suitable block copolymers include those with Mₙ of about 1×10³ to about 1×10⁷ g/mol and include diblock, triblock, BCPs of higher order (i.e., tetrablock, pentablock, etc.). Polydispersity index (PDI) of a block copolymer is the measure of heterogeneity of the size of molecules and shows the distribution of molar mass in the BCP sample. It is the ratio of average molar mass (M_{w}) and number-average molar mass (Mₙ). The PDI of at least one embodiment of a BCP disclosed herein is in the range of about 1.0 to about 3.0.

Large area (>300 cm²) freestanding BCP films as described herein can be produced on a traditional roll-to-roll manufacturing platform. The films can handle the normal process stress/strains without being destroyed during the manufacturing process. Thin film according to the present disclosure adhere well with the substrate and do not delaminate from the substrate during the casting run.

The thin films disclosed reject solutes with at least two dimensions that are greater than the average diameter of the selective layer's pores. The solute's size might be determined by any number of or combination of analytical tools, for example: electron microscopy, light scattering, chromatography, atomic force microscopy, etc. The solution rejection can be shown, for example, by challenging the film with solutes of known size and measuring the concentration in both feed and permeate. In some instances, films according to the present disclosure can reject a solute larger than the most selective pores with a log reduction value (LRV) of at least 3 (i.e. 99.9% rejection). In some instances, films according to the present disclosure can reject a solute larger than the most selective pores with a log reduction value (LRV) of at least 4 (i.e. 99.99% rejection). In some instances, films according to the present disclosure can reject a solute larger than the most selective pores with a log reduction value (LRV) of at least 6 (i.e. 99.9999% rejection). Examples of suitable solutes include, but are not limited to: viruses, bacteria, proteins, particulates, cells, nanospheres, and nanoparticles.

In addition to the aforementioned ease of production and performance benefits, there is tremendous cost advantage in making freestanding films as described herein. A freestanding film not only requires less precursor BCP, but also reduces the overall cost of manufacturing as the porous support is expensive.

### DETAILED DESCRIPTION OF THE PREFERRED EMBODIMENTS

In some examples of embodiments, freestanding pleatable isoporous mesoporous BCP films comprise poly(isoprene-b-styrene-b-4-vinylpyridine), also called “ISV”. In said examples, the films comprise ISV98. The composition and size are ISV98 as follows: ISV98 has a 41.2 kg/mol poly(isoprene) block, a 86.7 kg/mol poly(styrene) block, a 15.1 kg/mol poly(4-vinylpyridine) block, and an overall size of 153.2 kg/mol. The freestanding films are prepared according to the method above.

### Example 1

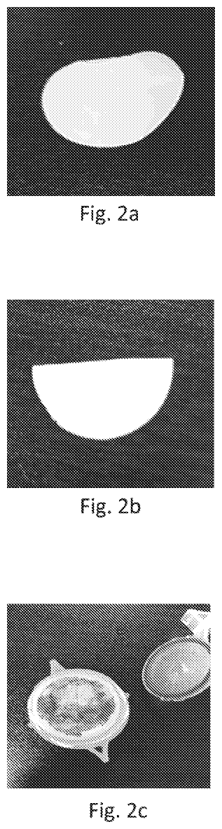

Freestanding ISV BCP films are tested for pleatability. Two 25 mm circular film discs adjacent to each other are cut from a larger sheet of film. One disc is kept wet as a control, and the other disc is dried for at least 48 hours at ambient conditions prior to exposing the dry film to pleatability tests. The control is challenged with 20 nm gold nanoparticles (from nanoComposix), and the film shows >99.9% rejection of gold nanoparticles. The diameter of gold nanoparticles is 18.9+/−2.3 nm, with a coefficient of variance 12.2% and >99.99% purity. The gold nanoparticles are dispersed in aqueous 2 mM Citrate buffer. The concentration of the gold nanoparticles is 0.05 mg/ml. FIG. 2 shows a dried freestanding film being folded and unfolded, after challenging with 20 nm gold nanoparticles. FIG. 2A shows a circular film disc that is cut from a larger sheet of film. The disc is dried at ambient conditions for at least 24 hours. In addition, FIG. 2A shows the disc lying flat on the surface after drying, without shrinking or deforming into a tube. The disc is then folded in half, first on the non-selective side and then on the selective side (FIG. 2B). A 150 g weight is put on the folded disc and is left for at least 24 hours. After 24 hours the weight is lifted, and the disc is again unfolded such that a crease from pleating is left at the center as shown in FIGS. 2B and 2C. A weight is put on the unfolded disc for at least 24 hours to make it flat. The disc is then rehydrated by soaking in deionized water for at least 30 minutes. The disc is then challenged with an aqueous solution of 10 mL of 20 nm gold nanoparticles in a polypropylene holder at 2.1 bar. This material is shown after the test with the holder disassembled in FIG. 2C. The discoloration on the surface of the film is due to adsorbed gold nanoparticles as shown in FIG. 2C. The feed and the permeate samples are collected pre- and post-run, respectively. The UV absorbance of the 20 nm gold nanoparticles is at 520 nm. Mass balance is performed on feed and permeate samples using UV absorbance value at 520 nm to determine the rejection characteristic of the thin films. The film shows >99.9%, rejection of gold nanoparticles indicating the integrity of the thin film after pleating multiple times. A similar experiment was performed except that the film is pleated in the other direction, i.e. away from the skin layer. This film also shows >99.9% rejection of 20 nm gold nanoparticles.

### Example 2

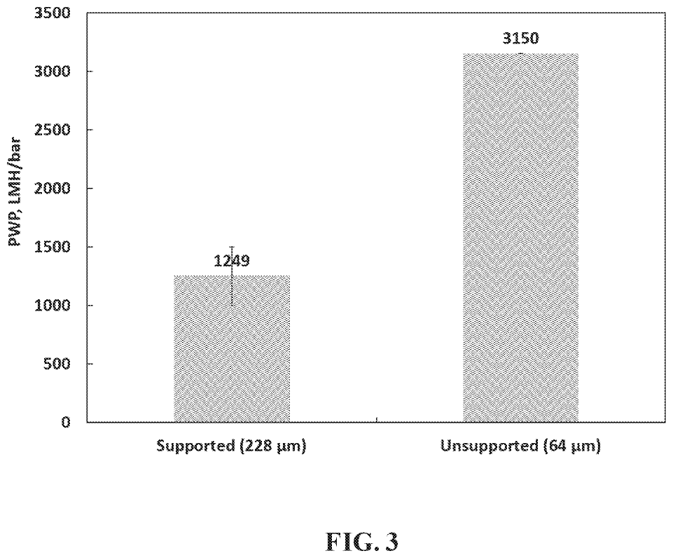

ISV98 films are prepared for comparison: one unsupported according to the above method, and one prepared on a polyester support but otherwise using the same formulation and casting conditions. The hydraulic permeabilities of the substrate supported and freestanding films are shown in FIG. 3. Hydraulic permeabilities are conducted in a stirred cell (Amicon). The permeability is measured in terms of LMH/bar (L/m/h/bar) at a 2.1 bar transmembrane pressure. The permeability of freestanding film is 3150 LMH/bar, and the permeability of the supported film is 1250 LMH/bar. This indicates that the permeability of freestanding film is ˜2.5 times higher compared to the supported thin film. Additionally, the substrate supported film is 228 μm thick including the support; while the freestanding film is just 64 μm thick. The higher hydraulic permeability of freestanding film might be partially attributed to 3.5 times lower thickness than that of the substrate supported film. Both the supported and unsupported thin films show >99.9% rejection of 20 nm gold nanoparticles.

### Example 3

In one example of an embodiment, an aqueous buffer solution of the bacteriophage PP7 was filtered in the normal flow mode configuration through a single layer of a pleatable BCP isoporous mesoporous ISV98 freestanding film with the mesoporous isoporous selective side facing the feed. The PP7load titer is 8 logs and the log removal value (LRV) was >6. The “greater than” denotation means there was no measured infectivity in the assay, which corresponds to no virus “breakthrough”. A film with LRV of 6 means that it reduces the viral load by a factor of 1,000,0000 (10⁶).

### Example 4

In one example of an embodiment, a method to fabricate pleatable freestanding thin films is shown. The process involves the formulation of a polymer solution comprising: (1) 10 wt % BCP relative to total solution weight, such as ISV; (2) 90 wt % 1,4-dioxane and acetone in ratio 7:3 by weight, and casting onto a polyester non-porous substrate. Next, a portion of the 1,4-dioxane and/or acetone in the extruded ISV BCP film is allowed to evaporate for a controlled time (40-120 seconds) under controlled humidity (35-45%), temperature (18-23° C.), casting speed (3-4 ft/min), and air flow (5-15 ft/min). The film is immersed into a coagulation bath (water and/or isopropyl alcohol), preferably at a temperature between 18° C. and 23° C. The solution coagulates and forms a porous separation layer through the well-known immersion precipitation process. The membrane is then rinsed with water for 1 minute. The porous material that results is a pleatable, freestanding film comprising: a self-assembled mesoporous isoporous top layer residing above a macroporous substructure. It will be readily apparent to one of ordinary skill in the art that other known block polymers may be substituted for the ISV polymer.

### Example 5

In one example in an embodiment, a 2×4″ film strip of a pleatable freestanding ISV film is cut from a larger sheet and wrapped around a needle having a radius of 0.3 mm. The film did not crack or disintegrate.

### Example 6

In one example of an embodiment, a pleatable isoporous BCP film comprising ISV is made according to the method disclosed, wherein the total continuous area of the film is >300 cm²; a portion of the film is subjected to the pleatability gold nanoparticle rejection test as described above and the rejection is >99.9% (3 logs).

### Example 7

In an example of an embodiment, a pleatable isoporous BCP film comprising poly(styrene-block-2-vinylpyridine) is made according to the method disclosed; a portion of the film is subjected to the pleatability gold nanoparticle rejection test as described above and the rejection is >99.9% (3 logs).

### Example 8

In an example of an embodiment, a pleatable isoporous BCP film comprising poly(styrene-block-4-vinylpyridine) is made according to the method disclosed; a portion of the film is subjected to the pleatability gold nanoparticle rejection test as described above and the rejection is >99.9% (3 logs).

### Example 9

In an example of an embodiment, a pleatable isoporous BCP film comprising poly(isoprene-block-styrene-block-4-vinylpyridine) is made according to the method disclosed; a portion of the film is subjected to the pleatability gold nanoparticle rejection test as described above and the rejection is >99.9% (3 logs).

### Example 10

In an example of an embodiment, a pleatable isoporous BCP film comprising poly(isoprene-block-styrene-block-ethylene oxide) is made according to the method disclosed; a portion of the film is subjected to the pleatability gold nanoparticle rejection test as described above and the rejection is >99.9% (3 logs).

### Example 11

In an example of an embodiment, a pleatable isoporous BCP film comprising ISV is made according to the method disclosed and the average film thickness is 23 μm; a portion of the film is subjected to the pleatability gold nanoparticle rejection test as described above and the rejection is >99.9% (3 logs).

### Example 12

In an example of an embodiment, a pleatable isoporous BCP film comprising ISV is made according to the method disclosed and the average film thickness is 55 μm; a portion of the film is subjected to the pleatability gold nanoparticle rejection test as described above and the rejection is >99.9% (3 logs).

### Example 13

In an example of an embodiment, a pleatable isoporous BCP film comprising ISV is made according to the method disclosed and the average film thickness is 72 μm; a portion of the film is subjected to the pleatability gold nanoparticle rejection test as described above and the rejection is >99.9% (3 logs).

1. A pleatable asymmetric freestanding isoporous block copolymer (BCP) film.

2. The pleatable asymmetric freestanding isoporous BCP film of claim 1, wherein the asymmetric isoporous BCP film has a thickness ranging from about 5 μm to about 75 μm.

3. The pleatable asymmetric freestanding isoporous BCP film of claim 1, wherein the asymmetric isoporous BCP film comprises mesopores, the mesopores having an average pore size between about 1 nm and about 50 nm.

4. The pleatable asymmetric freestanding isoporous BCP film of claim 1, wherein the asymmetric isoporous BCP thin film has a radius of curvature of at most about 0.3 mm.

5. The pleatable asymmetric freestanding isoporous BCP film of claim 1, wherein the BCP comprises at least one block comprising:
Poly(butadiene), Poly(isobutylene), Poly(isoprene), Poly(ethylene), Poly(styrene), Poly(methyl acrylate), Poly(butyl methacrylate), Poly(ethersulfone), Poly(methyl methacrylate), Poly(n-butyl acrylate), Poly(2-hydroxyethyl methacrylate), Poly(glycidyl methacrylate), Poly(acrylic acid), Poly(acrylamide), Poly(sulfone), Poly(vinylidene fluoride), Poly(N,N-dimethylacrylamide), Poly(2-vinylpyridine), Poly(3-vinylpyridine), Poly(4-vinylpyridine), Poly(ethylene glycol), Poly(propylene glycol), Poly(vinyl chloride), Poly(tetrafluoroethylene), Poly(ethylene oxide), Poly(propylene oxide), Poly(N-isopropylacrylamide), Poly(dimethylaminoethyl methacrylate), Poly(amic acid), Poly(dimethylsiloxane), Poly(lactic acid), Poly(isocyanate), Poly(ethyl cyanoacrylate), Poly(acrylonitrile), Poly(hydroxystyrene), Poly(methylstyrene), Poly(ethyleneimine), Poly(styrene sulfonate), Poly(allylamine hydrochloride), Poly(pentafluorostyrene), Poly(2-(perfluorohexyl)ethyl methacrylate), or a substituted equivalent of any of the above.

6. The pleatable asymmetric freestanding isoporous BCP film of claim 1, wherein the BCP has Mₙ of about 1×10³ to about 1×10⁷ g/mol.

7. The pleatable asymmetric freestanding isoporous BCP film of claim 1, wherein the PDI (polydispersity index) of the BCP is about 1.0 to about 3.0.

8. The pleatable asymmetric freestanding isoporous BCP film of claim 1, wherein the film is one continuous piece and has an area of at least 300 cm².

9. A pleatable asymmetric isoporous block copolymer (BCP) thin film wherein the film has a Log Reduction Value (LRV) of greater than 3 for a solute that is larger than the average pore diameter of the film in at least two perpendicular dimensions.

10. A method for forming an asymmetric freestanding isoporous block copolymer (BCP) film, comprising the steps of:
(a) formulating a polymer solution by mixing at least one block copolymer, wherein at least one BCP with at least one solvent;
(b) extruding the polymer solution into a film on a nonporous substrate;
(c) evaporating at least a portion of at least one chemical of the polymer solution; and
(d) immersing the film into a coagulation bath.

11. The method of claim 10, wherein the polymer solution comprises at least one of the following: Acetic acid, Acetone, Acetonitrile, Benzene, Chloroform, Cyclohexane, Dichloromethane, Dimethoxyethane, Dimethyl sulfoxide, Dimethylacetamide, Dimethylformamide, 1,4-Dioxane, Ethanol, Ethyl acetate, Formic acid, Hexane, Methanol, N-Methyl-2-pyrrolidone, Propanol, Pyridine, Sulfolane, Tetrahydrofuran, or Toluene.

12. The method of claim 10, wherein the coagulation bath comprises water and/or isopropyl alcohol.

13. The method of claim 10, wherein the concentration of the BCP in the casting solution is in the range of about 1% to about 30% by weight.

14. A method of claim 10, wherein the film stays adhered to the non-porous substrate by:
an edge gluing mechanism, a tethering operation, using an air knife, using one or more blowers, or using a vacuum.

15. The method of claim 10, further comprising:
(e) rinsing the BCP film.
